(19) United States
(12) Patent Application Publication
(10) Pub. No.: US 2011/0035497 A1
(43) Pub. Date: Feb. 10, 2011

(54) SYSTEM AND METHOD FOR PROVIDING GLOBAL SERVER LOAD BALANCING

(75) Inventors: Thomas Daly, Nashua, NH (US); Jeremy Hitchcock, Manchester, NH (US)

Correspondence Address: SHEEHAN PHINNEY BASS & GREEN, PA;c/o PETER NIEVES, 1000 ELM STREET, MANCHESTER, NH, 03105-3701, US

(73) Assignee: Dynamic Network Services, Inc., Manchester, NH (US)

(21) Appl. No.: 12/535,726

(22) Filed: Aug. 5, 2009

(51) Int. Cl. G06F 15/173

(52) U.S. Cl. 709/226

(57) ABSTRACT

A server is provided containing a storage device, and memory, and a processor. The processor is configured by the memory to perform the steps of: receiving a request for data from a client device; selecting a customer content server that is geographically closest to the client device, wherein geographical closeness is measured by closeness within a network path; and providing the client device with information to access the customer content server that is geographically closest.

### FIELD OF THE INVENTION

The present invention relates generally to telecommunication, and more specifically to automatic balancing of data requests in a content delivery network.

### BACKGROUND OF THE INVENTION

A typical content delivery network has multiple points of presence (POPs). As an example there may be a first POP (POP1), a second POP (POP2), and a third POP (POP3). Traffic routing services are typically provided for automatically providing access of users to specific POPs within the content delivery network upon request. This process typically entails a customer that has a number of POPs contacting a content delivery network (CDN) provider with the number of POPs via which the customer wants access to content. The CDN provides access to customer content via the POPs, each of which is within the network of the CDN provider. As a client of the customer who enters the network of the CDN provider, the CDN provider will use its best effort to direct a client to what is believed to be an optimum POP.

As an example, a customer of the CDN provider may have three POPs on their network and desire to have a balanced load across all three POPs. A typical CDN automatically assists in the process of getting a user of the content delivery network (client) to the most optimal POP based on factors, such as, but not limited to, connection speed, latency, jitter, and bandwidth. In such systems, the CDN provider automatically selects the optimal POP for the user, as opposed to the user selecting a POP. It should be noted that the POPs of the content delivery network typically belong to the same party, and are within the same network.

The abovementioned method of connecting a client to content are computation intensive and may only leverage one network. Thus, a heretofore unaddressed need exists in the industry to address the aforementioned deficiencies and inadequacies.

### SUMMARY OF THE INVENTION

Embodiments of the present invention provide a system and method for providing global load balancing. Briefly described, in architecture, one embodiment of the system, among others, can be implemented as follows. A server is provided containing a storage device, and memory, and a processor. The processor is configured by the memory to perform the steps of: receiving a request for data from a client device; selecting a customer content server that is geographically closest to the client device, wherein geographical closeness is measured by closeness within a network path; and providing the client device with information to access the customer content server that is geographically closest.

The present invention also provides a network having global server load balancing within the network, wherein the network contains an authoritative domain name system (ADNS) server and a first HTTP redirect server. The ADNS server contains a storage device, a memory, and a processor. The processor is configured by the memory to perform the steps of: receiving a request for data from a client device; selecting an HTTP redirect server, among a series of HTTP redirect servers, that is geographically closest to the client device, wherein geographical closeness is measured by closeness within a network path, and wherein the selected HTTP redirect server may be the first HTTP redirect server; and providing the client device with information to access the selected HTTP redirect server that is geographically closest. The first HTTP redirect server contains a storage device, a memory, and a processor. The processor is configured by the memory to perform the steps of: receiving a request for data from a client device; selecting a customer content server that is geographically closest to the client device, wherein geographical closeness is measured by closeness within a network path; and providing the client device with information to access the customer content server that is geographically closest.

The present invention can also be viewed as providing methods for providing global server load balancing. In this regard, one embodiment of such a method, among others, can be broadly summarized by the following steps: receiving a request for data from a client device; selecting a customer content server that is geographically closest to the client device, wherein geographical closeness is measured by closeness within a network path; and providing the client device with information to access the customer content server that is geographically closest.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating a network in which the present system and method is provided, in accordance with a first exemplary embodiment of the invention.

FIG. 2 is a block diagram further illustrating the customer content server of FIG. 1.

FIG. 3 is a flow chart illustrating interaction within the network of FIG. 1 in response to a client request for data, in accordance with the first exemplary embodiment of the invention.

FIG. 4 is a schematic diagram illustrating a network in which the present system and method is provided, in accordance with a second exemplary embodiment of the invention.

FIG. 5 is a flow chart illustrating interaction within the network of FIG. 1 in response to a client request for data, in accordance with the second exemplary embodiment of the invention.

### DETAILED DESCRIPTION

The present system and method provides for automatic global server load balancing without use of analytical selection of POPs. The system and method does not provide for IP address analysis, but instead, the ADNS servers all have the same IP address through IP anycast. As is known by those having ordinary skill in the art, anycast is a network addressing and routing scheme whereby data is routed to the “nearest” or “best” destination as viewed by the routing topology. In the present system and method, geographical closeness is utilized to provide a best network path from either an ISP RDNS server to a customer content server or from a client device to a customer content server. Herein, the term geographical closeness refers to approximate closeness based on a network path. An example of geographical closeness would be the least number of hops from a first point to a second point.

It should be noted that, due to the abovementioned configuration, the IP address of the user is not considered in selection of a customer content server, but instead, the network to which the IP address is routed through its autonomous system number is considered. Further, by allowing each customer content server to be individually associated with an individual ISP, the ISP servers need not all be owned by the same entity.

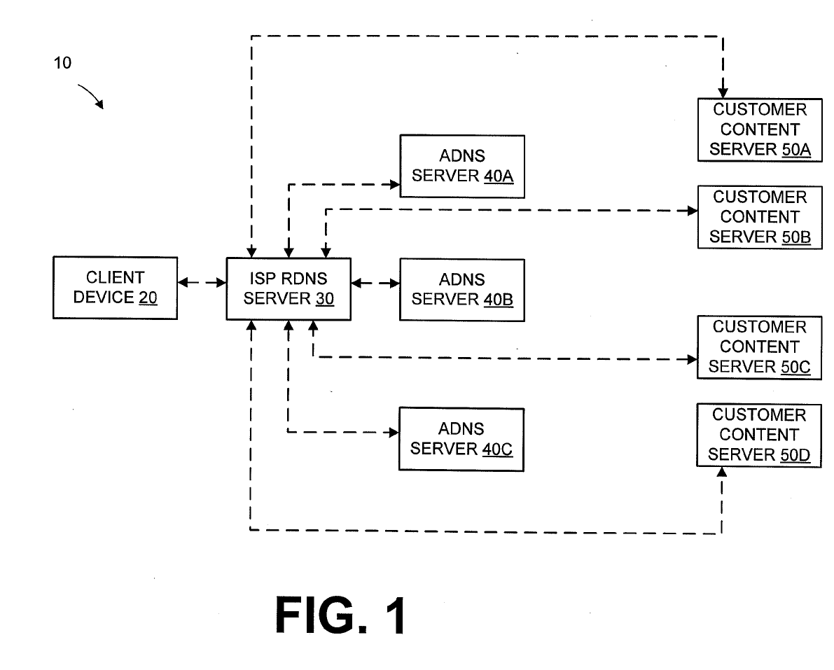

FIG. 1 is a schematic diagram illustrating a network 10 in which the present system and method is provided, in accordance with a first exemplary embodiment of the invention. As is shown by FIG. 1, the network 10 contains a client device 20. It should be noted that the client device 20 could be one of many different devices such as, but not limited to, a desktop computer, a laptop, or a mobile phone. Specifically, the client device 20 is a device from which a client, or an individual, can make a request for access to a Web site via entry of a Web extension, such as www.domain.com. As a result, the client device contains an Internet/Web browser or other software application capable of allowing the client to view content stored at a remote location.

The client device 20 is connected via the Internet to an Internet service provider (ISP) recursive domain name system (RDNS) server 30. The ISP RDNS server 30 is responsible to the client for providing Internet access and provides translation of a received domain name into an Internet protocol (IP) address. It should be noted that, in accordance with a first exemplary embodiment of the invention, the connection between the client device 20 and the ISP RDNS server 30 is predefined by the client so that there is no computation required for selection of an ISP RDNS server. Specifically, the client selects his/her ISP beforehand and the ISP provides the connection between the client device 20 and an ISP RDNS server 30.

In accordance with an alternative embodiment of the invention, the client device 20 may be capable of providing the translation of received domain names into an IP address. In such an embodiment, there would not be a need for an ISP RDNS server.

The ISP RDNS server 30 of the first exemplary embodiment is connected, via the Internet, to a series of authoritative DNS (ADNS) servers 40A, 40B, 40C. It should be noted that the number of ADNS servers may be more or fewer than those illustrated by FIG. 1, in fact, there may only be a single ADNS server in the network 10. The ADNS servers 40 each have the same IP address. In addition, the ADNS servers 40 are reachable in multiple locations by the same IP address by using the border gateway protocol (BGP) or another comparable protocol. As is known by those having ordinary skill in the art, BGP is an exterior gateway routing protocol that enables groups of routers to share routing information so that efficient, loop-free routes can be established.

It should be noted that, while the ADNS servers 40 each have the same IP address, they are not located in the same location. Specifically, each ADNS server 40 may be located in the same location or in remote locations. As a result, a distance from the ISP RDNS server 30 to each ADNS server 40 may be different. As an example, the distance from a first ISP RDNS server 30 to a first ADNS server 40A may be identified by a zero hop distance, while a distance from the first ISP RDNS server 30 to a second ADNS server 40B may be identified by a two hop distance.

The ISP RDNS server 30 connects to an ADNS server 40 that is geographically closest to the location of the ISP RDNS server 30. One way of determining a closest location is by selecting the ADNS server 40 that is the least number of hops from the ISP RDNS server 30, which is typically used on the Internet.

Each ADNS server 40 is associated with one or more customer content server 50, also referred to as a point of presence (POP). It should be noted that association between an ADNS server 40 and one or more customer content server 50A, 50B, 50C, 50D may be established through a direct physical connection or an indirect connection (not a direct physical connection), via the Internet. As a result, an ADNS server 40 need not communicate exclusively with a specific customer content server 50.

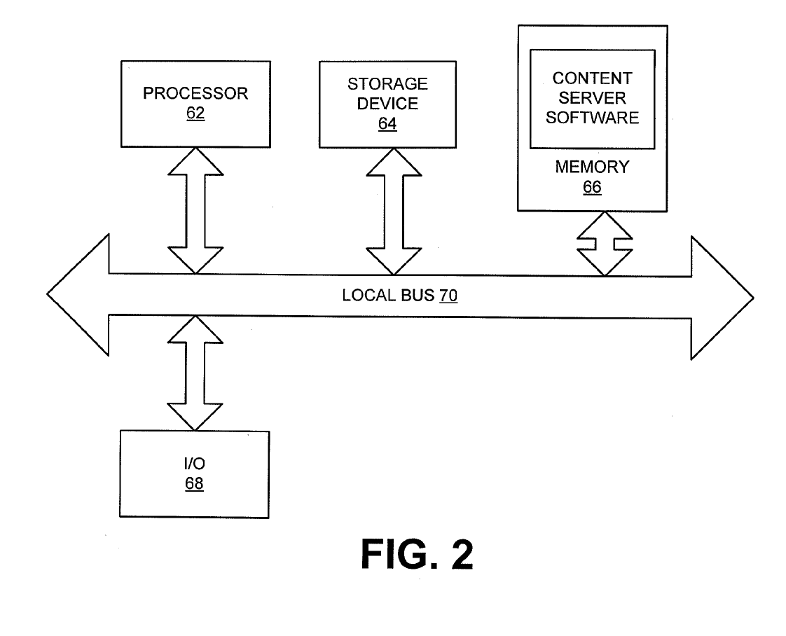

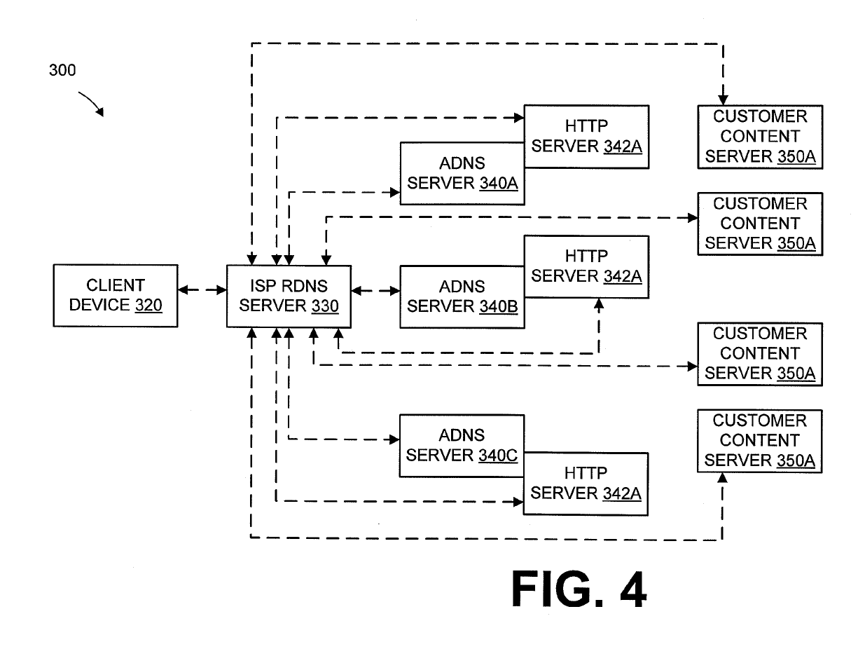

It should be noted that the ADNS server 40 has a structure that is similar to structure of a Web data server (FIG. 2), which is described in detail below. Since the structure of the ADNS server 40 is similar to the structure of the Web data server (FIG. 2), additional description of the structure of the ADNS server 40 is not provided herein. A description of functionality provided by the ADNS server 40 is provided by FIG. 4, which is described in detail hereinafter.

Preferably, each ADNS server 40 has geolocation information stored therein that is capable of being used to select a customer content server 50 that provides a shortest network geographical distance from the ISP RDNS server 30 to a customer content server 50. Again, herein, the term geographical closeness refers to approximate closeness based on a network path.

While FIG. 1 shows that the network 10 contains four customer content servers 50A-50D, one having ordinary skill in the art would appreciate that the network 10 may have more or fewer customer content servers 50. As is known by those having ordinary skill in the art, a customer content server provides an interface point between locations within a network. Typically, the customer content servers 50A-50D are owned by the same party, although it is noted that, in accordance with the present invention, it is not necessary for all customer content servers 50A-50D to be owned by the same party. The customer content server 50 contains content that is being sought by the client. As an example, such content may be, for example, a Web page or files requested by the client.

FIG. 2 is a block diagram further illustrating a typical customer content server 50. As is known by one having ordinary skill in the art, a typical customer content server 50 contains a processor 62, a storage device 64, a memory 66 having content server software stored therein, inputs and outputs 68, and a local bus 70 allowing for communication within the customer content server 50. The content is stored within the storage device 64, although it should be noted that the content may instead be stored at a location remote from the customer content server 50.

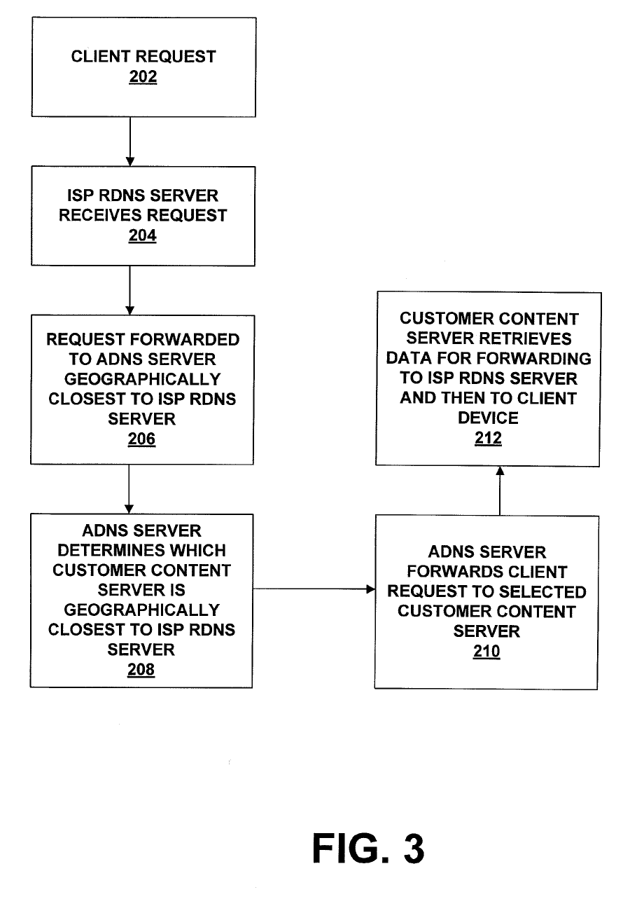

FIG. 3 is a flow chart 200 illustrating interaction within the network 10 of FIG. 1 in response to a client request for data, in accordance with the first exemplary embodiment of the invention. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, a client makes a request, via the client device 20, for a Web site, such as by using their Internet browser to search for a domain name in the format of www.domain.com. The request is received by an ISP RDNS server 30 that has been selected by the client (block 204). Preferably, the ISP RDNS server 30 is preselected by the client so that the request from the client goes directly to the preselected ISP RDNS server 30. It should be noted that the request may instead be for data stored on a Web data server.

The ISP RDNS server 30 forwards the request to the ADNS server 40 that is geographically closest to the ISP RDNS server 30 (block 206). As previously mentioned, geographical closeness between the ISP RDNS server 30 and an ADNS server 40 may be determined by looking for the least number of hops between the two. As an example, the ISP RDNS server 30 may be located in New Hampshire, while a first ADNS server 40A is located in Florida, with one hop in New York and one hop in Georgia. Alternatively, a second ADNS server 40B may be located in New York with no hops between the ISP RDNS server 30 and the second ADNS server 40B. In this example, the second ADNS server 40B would provide the closest geographical location.

In accordance with an alternative embodiment of the invention, if the geographically closest ADNS server 40 is not working, the next geographically closest ADNS server 40 is selected by the ISP RDNS server 30.

After receipt of the client request from the ISP RDNS server 30, the ADNS server 40 determines which customer content server 50 is geographically closest to the ISP RDNS server 30 (block 208). Functionality performed by the ADNS server 40 to make this determination is described in detail with regard to the flow chart of FIG. 4.

The ADNS server 40 determines to which customer content server 50 to forward the client request by use of the following determination. The ADNS server 40 will by default send traffic to the geographically closest customer content server 50. The customer may elect to balance an ADNS server 40 to multiple customer content servers 50 through any standard number of ratios. In the event that the ADNS server 40 determines that a specific customer content server 50 is unavailable, the ADNS server 40 will choose the next closest customer content server 50, or there may be a global default rule. The ADNS server 40 may also use a number of other monitoring, weighting, geographic, or network factors based on the client device 20 and the customer content server 50. All such factors are intended to be included with the present description.

As shown by block 210, once the ADNS server 40 has determined which customer content server 50 is geographically closest to the ISP RDNS server 30, the ADNS server forwards the client request to the selected customer content server 50. The customer content server 50 then retrieves the data associated with the client request for return to the ISP RDNS server 30, and finally, to the client device 20 (block 212). It should be noted that, in accordance with an alternative embodiment of the invention, if the geographically closest customer content server 50 is not working, the next geographically closest customer content server 50 is selected by the ADNS server 40.

While the first embodiment of the invention makes the assumption that the client is geographically close by network path to the ISP RDNS server, in certain situations this is not the case. The system and method of the second exemplary embodiment of the invention compensates for this change. Specifically, in the second exemplary embodiment there are HTTP redirect servers that are provided for purposes of allowing determination of which customer content server is closest to the client device, instead of determining which customer content server is closest to the ISP RDNS server.

As is known by those having ordinary skill in the art, server side redirection is a method of URL redirection using an HTTP status code issued by a Web server in response to a request for a particular URL. The result is to redirect the Web browser of a user to another Web page having a different URL.

FIG. 4 is a schematic diagram illustrating a network 300 in which the present system and method is provided, in accordance with a second exemplary embodiment of the invention. As is shown by FIG. 4, the network 300 contains a client device 320, which is the same as the client device 20 of FIG. 1. The client device 320 is connected via the Internet to an ISP RDNS server 330, which is the same as the ISP RDNS server 30 of FIG. 1. It is to be noted that the ISP RDNS server 330 to which the client device 320 is connected might not be located close to the client device.

The ISP RDNS server 330 of the second exemplary embodiment is connected, via the Internet, to a series of ADNS servers 340A, 340B, 340C. It should be noted that the number of ADNS servers may be more or fewer than those illustrated by FIG. 4, in fact, there may only be a single ADNS server in the network 300. The ADNS servers 340 are reachable in multiple locations by the same IP address by using the BGP or another comparable protocol.

It should be noted that, while the ADNS servers 340 each have the same IP address, they are not located in the same location. Specifically, each ADNS server 340 may be located in the same location or in remote locations. As a result, a distance from the ISP RDNS server 330 to each ADNS server 340 may be different. As an example, the distance from a first ISP RDNS server 330 to a first ADNS server 340A may be identified by a zero hop distance, while a distance from the first ISP RDNS server 330 to a second ADNS server 340B may be identified by a two-hop distance.

The ISP RDNS server 330 connects to an ADNS server 340 that is geographically closest to the location of the ISP RDNS server 330. One way of determining a closest location is by selecting the ADNS server 340 that is the least number of hops from the ISP RDNS server 330.

Each ADNS server 340 is paired, via the Internet, to an HTTP redirect server 342. As a result, since three ADNS servers 340A, 340B, 340C are shown in FIG. 4, three HTTP redirect servers 342A, 342B, 342C are also shown in FIG. 4. Each HTTP redirect server 342 is capable of determining a geographically closest customer content server 350 to the client device 320.

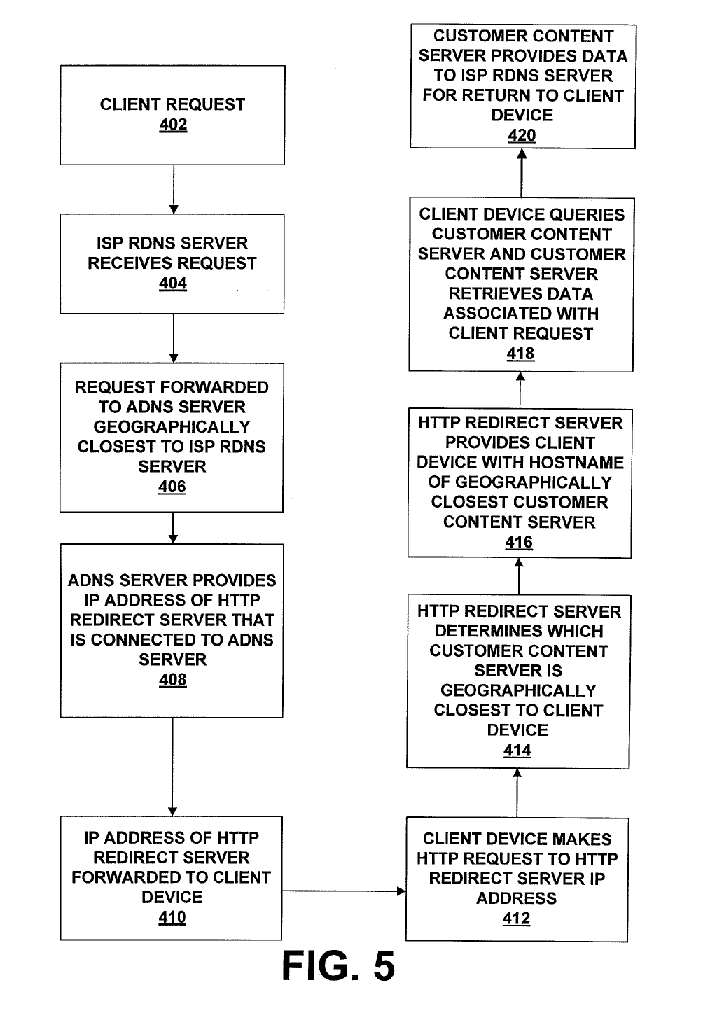

When the ADNS server 340 is queried for the answer of www.domain.com, the ADNS server 340 provides the answer that is the IP address for the HTTP redirect server 342 that is connected to the ADNS server 340. As is shown by FIG. 4, there are a series of HTTP redirect servers 342A-342C in the network. Referring to FIG. 4, as an example, ADNS server 340B returns HTTP redirect server 342B. This answer is provided to the ISP RDNS server 330, which is then returned to the client device 320 for communication, as described below with regard to FIG. 5.

As is shown by FIG. 4, in the network of the second exemplary embodiment of the invention there are also a series of customer content servers 350. Similar to the network of FIG. 1, while FIG. 4 shows that the network 300 of the second embodiment contains four customer content servers 350A-350D, one having ordinary skill in the art would appreciate that the network 300 may have more or fewer customer content servers 350. Also similar to the network of FIG. 1, the customer content server 350A-350D have the content that is being sought by the client stored therein.

As previously mentioned, each HTTP redirect server contains geolocation information stored therein that is capable of being used to select a customer content server 350 that provides a shortest geographical distance, via network path, from the client device 320 to the customer content server 350. The structure of the HTTP redirect server 342 is similar to the structure of the ADNS server 340, and therefore, structure of the HTTP redirect server 342 is not described herein. A description of functionality provided by the HTTP redirect server 342, as well as the rest of the network 300 of FIG. 4, is provided by FIG. 5.

FIG. 5 is a flow chart 400 illustrating interaction within the network 300 of FIG. 4 in response to a client request for data, in accordance with the second exemplary embodiment of the invention. As is shown by block 402, a client makes a request, via the client device 320, for a Web site, such as by using their Internet browser to search for a domain name in the format of www.domain.com. The request is received by an ISP RDNS server 330 that has been selected by the client (block 404). Preferably, the ISP RDNS server 330 is preselected by the client so that the request from the client goes directly to the preselected ISP RDNS server 330. It should be noted that the request may instead be for data stored on a Web data server.

The ISP RDNS server 330 forwards the request to the ADNS server 340 that is geographically closest, via network path, to the ISP RDNS server 330 (block 406). (CLOSEST TO THE ISP RDNS SERVER OR THE CLIENT DEVICE?) As previously mentioned, geographical closeness between the ISP RDNS server 330 and an ADNS server 340 may be determined by looking for the least number of hops between the two. As an example, the ISP RDNS server 330 may be located in New Hampshire, while a first ADNS server 340A is located in Florida, with one hop in New York and one hop in Georgia. Alternatively, a second ADNS server 340B may be located in New York with no hops between the ISP RDNS server 330 and the second ADNS server 340B. In this example, the second ADNS server 340B would provide the closest geographical location.

After receipt of the client request from the ISP RDNS server 330, namely, a query for the answer of www.domain.com, the ADNS server 340 provides an answer that is the IP address for the HTTP redirect server 342 that is connected to the ADNS server 340 (block 408). This answer is provided to the ISP RDNS server 330, which is then returned to the client device 320 (block 410).

In accordance with an alternative embodiment of the invention, the ADNS server 340 may determine which HTTP redirect server 342 is geographically closest, via network path, to the client device 320. The IP address of the geographically closest HTTP redirect server 342 may then be provided to the client device 320.

Returning to FIG. 4 and the second exemplary embodiment, as shown by block 412, the client device then makes an HTTP request to the IP address of the HTTP redirect server 342 that is geographically closest, via network path, to the client device 320. When the connection to the HTTP redirect server 342 is made, the HTTP redirect server 342 determines which customer content server 350 is geographically closest, via network path, to the client device 320 (block 414). To perform this function, the HTTP redirect server 342 performs functionality similar to the functionality of the ADNS server 40 of FIG. 1 in determining the geographically closest customer content server 50 to the ISP RDNS server 30. The HTTP redirect server 342 then provides the Web browser of the client device 320 with the hostname of the determined geographically closest customer content server 350 (block 416).

As shown by block 418, the client device 320, via the ISP RDNS server 330 then queries the geographically closest, via network path, customer content server and the customer content server 350 retrieves data associated with the client request. The customer content server 350 then provides the data to the ISP RDNS server 330 for return to the client device 320 (block 420).

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A server, comprising:
a storage device;
a memory; and
a processor configured by the memory to perform the steps of:
receiving a request for data from a client device;
selecting a customer content server that is geographically closest to the client device, wherein geographical closeness is measured by closeness within a network path; and
providing the client device with information to access the customer content server that is geographically closest.

2. The server of claim 1, wherein the selected customer content server is one of a series of customer content servers.

3. The server of claim 2, wherein the storage device has stored therein geolocation information of customer content servers to allow the processor to select the customer content server that is geographically closest by network path to the client device.

4. The server of claim 1, wherein the server is an authoritative domain name system server.

5. The server of claim 1, wherein the information to access the customer content server that is geographically closest is the Internet Protocol (IP) address of the customer content server.

6. The server of claim 1, wherein the data requested is a Web page.

7. A network having global server load balancing within the network, wherein the network comprises:
an authoritative domain name system (ADNS) server and a first HTTP redirect server, wherein the ADNS server further comprises:
a storage device;
a memory; and
a processor configured by the memory to perform the steps of:
receiving a request for data from a client device;
selecting an HTTP redirect server, among a series of HTTP redirect servers, that is geographically closest to the client device, wherein geographical closeness is measured by closeness within a network path, and wherein the selected HTTP redirect server may be the first HTTP redirect server; and
providing the client device with information to access the selected HTTP redirect server that is geographically closest.

8. The network of claim 7, wherein the first HTTP redirect server further comprises:
a storage device;
a memory; and
a processor configured by the memory to perform the steps of:
receiving a request for data from a client device;
selecting a customer content server that is geographically closest to the client device, wherein geographical closeness is measured by closeness within a network path; and
providing the client device with information to access the customer content server that is geographically closest.

9. The network of claim 8, wherein the selected customer content server is one of a series of customer content servers.

10. The network of claim 8, wherein the storage device of the first HTTP redirect server has stored therein geolocation information of customer content servers to allow the processor to select the customer content server that is geographically closest by network path to the client device.

11. The network of claim 7, wherein the storage device of the ADNS server has stored therein geolocation information of HTTP redirect servers to allow the processor to select the HTTP redirect server that is geographically closest by network path to the client device.

12. The network of claim 7, wherein the request for data from the client device is transmitted to the ADNS server by an Internet service provider (ISP) recursive domain name system (RDNS) server that is preselected by a user of the client device.

13. A method for providing global server load balancing, comprising the steps of:
receiving a request for data from a client device;
selecting a customer content server that is geographically closest to the client device, wherein geographical closeness is measured by closeness within a network path; and
providing the client device with information to access the customer content server that is geographically closest.
